(19) United States
(12) Patent Application Publication
(10) Pub. No.: US 2005/0282696 A1
(43) Pub. Date: Dec. 22, 2005

(54) Cross ply of plastic tapes as well as process and device for the manufacture thereof

(75) Inventor: Peter Schmalholz, Vosendorf (AT)

Correspondence Address: HOFFMANN & BARON, LLP, 6900 JERICHO TURNPIKE, SYOSSET, NY, 11791, US

(73) Assignee: Starlinger & Co. Gesellschaft M.B.H.

(21) Appl. No.: 11/181,338

(22) Filed: Jul. 11, 2005

(30) Foreign Application Priority Data
Mar. 11, 2003 (AT) A 379/2003

(51) Int. Cl. B31B 1/90

(52) U.S. Cl. 493/225

(57) ABSTRACT

The invention relates to a process and device for the manufacture of a cross ply of plastic tapes as well as to the cross ply itself. The process comprises:
a) providing a transverse web (1) comprising transverse plastic tapes (1a) interconnected by a synthetic layer (1b),
b) cutting transverse web pieces (1c) of equal lengths from the transverse web (1) and conveying the transverse web pieces (1c) to a connecting station (6), where the transverse web pieces (1c) are drawn in transversely to the direction of the longitudinal axis of their transverse plastic tapes,
c) providing a plurality of longitudinal plastic tapes (8),
d) supplying the longitudinal plastic tapes (8) in parallel arrangement to the connecting station (6),
e) connecting the longitudinal tapes (8) with supplied transverse web pieces (1c) at the connecting station (6) to form a cross ply (11, 19) by introducing a plastic melt layer (10) between the longitudinal plastic tapes (8) and the transverse web pieces (1c) as they are passed through the connecting station (6), and subsequent cooling of the plastic melt layer so that the direction of the longitudinal axis of the longitudinal plastic tapes (8) runs at an angle relative to the direction of the longitudinal axis of the plastic tapes of the transverse web pieces (1c).

The invention relates to a process and device for the manufacture of a cross ply of, preferably stretched, plastic tapes as well as to a cross ply of plastic tapes.

Nowadays, fabrics from stretched plastic tapes are widely used and are employed especially in the production of bags, for canvas fabrics, “big bags” with a load bearing capacity of 1000 kg and more, geotextiles etc. In comparison with other sheet materials such as films, fabrics are distinguished by their higher biaxial strength while having a lower weight per unit area. Furthermore, the manufacturing process for plastic tapes is technologically rather simple, compared with the production of films. However, the manufacturing process for fabrics from plastic tapes is associated with substantial drawbacks, such as a large requirement for space and personnel, noise, dirt, a large amount of waste material, strength losses of the tapes during weaving etc.

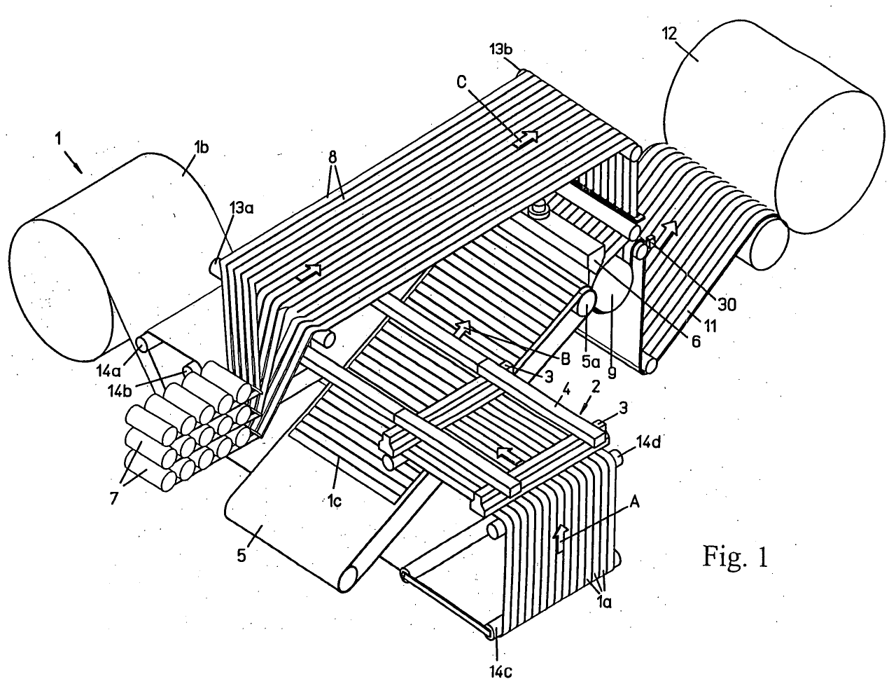

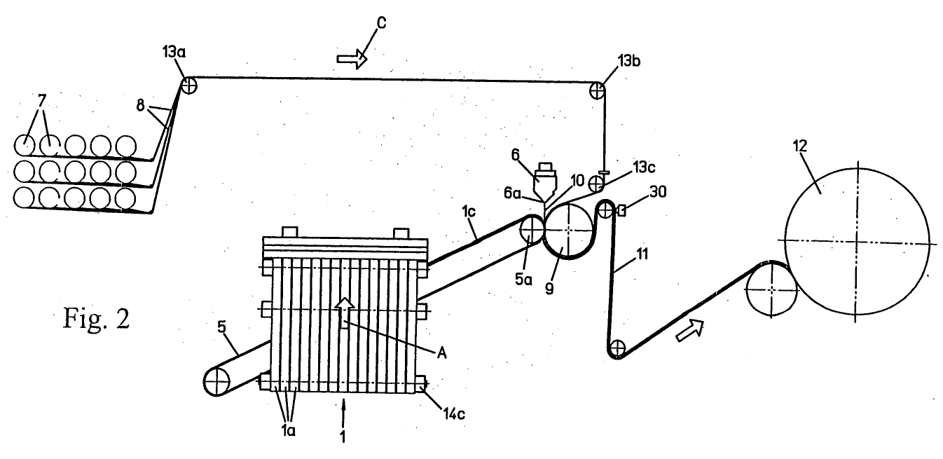

From WO 01/16418, a process and device for the manufacture of composite plates is known, wherein a bundle of parallel yarns is driven along a predetermined direction. A yarn layer transversely oriented relative to the above-indicated direction is associated with these yarns, with the yarn layer and/or the yarn bundle comprising at least one organic material and at least one reinforcing material. The overall assembly contains at least 10% by weight of an organic material. The overall assembly is heated while being moved in the predetermined direction and is fixed by heating and/or pressure and subsequently is cooled so that a composite strip is formed. However, this known device and the process have the disadvantage that, in the embodiment according to FIG. 1 of said document, the manufacturing process can proceed only very slowly, since an individual yarn has to be folded transversely across the bundle of yarns (indicated velocity: 120 strokes/minute) and then has to be cut off. In the embodiment according to FIG. 2, wherein several yarns are simultaneously directed transversely across the bundle of yarns, either a continuous motion of the yarn bundle is impossible again, or—in contrast to the illustration—a rectangular arrangement of the transverse yarns above the yarn bundle is impossible, since, in addition to the transverse speed component of the transverse yarns, a longitudinal speed component of the yarn bundle would always be provided.

From DE 27 07 584 A1, a film web reinforced by a network of tapes is known, wherein the network of tapes is composed of tapes extending across the film in zigzag fashion and crossing over each other. The manufacturing process comprises the passing of the film web underneath a rake or comb, which is movable transversely to the conveying direction of the film web and which applies a group of tapes in parallel arrangement to the film web, wherein the tapes are fixed to the film web by the simultaneous application of glue. Due to the relative movements of the film web and the rake, the tapes lie on the film web at an oblique angle. Furthermore, swellings form at the longitudinal edges of the film web, which swellings are caused by the reversal of the direction of the layer of the group of tapes.

It is the object of the present invention to provide a process and device for the manufacture of a cross ply of, preferably stretched, plastic tapes as well as a cross ply of plastic tapes, wherein the above-indicated disadvantages are avoided.

In order to achieve the above-mentioned object, the invention provides a process for the manufacture of a cross ply of plastic tapes, such as defined in claim 1. Advantageous embodiments of the process according to the invention are set forth in the dependent subclaims.

The process according to the invention provides the following advantages:
a high throughput during manufacture
less than 1% of waste material
low requirement for space and personnel
high overall efficiency
no tape-strength losses due to the process

According to an advantageous embodiment of the process according to the invention, the transverse web is provided by providing, first of all, a plurality of transverse plastic tapes, preferably in bobbins on unwinding creels, which are then guided in parallel arrangement to a coating station, where respective adjacent transverse plastic tapes are interconnected by applying a synthetic layer to at least one surface of the transverse plastic tapes. Said process can be carried out synchronously with the supply of the longitudinal plastic tapes to the connecting station so that the manufacture of the entire cross ply of plastic tapes can take place in one integral production step.

In order to impart desirable properties to the cross ply or to support its further processing, in an advanced development of the process for manufacturing a cross ply, it is provided that the longitudinal plastic tapes are coated in a coating station with a synthetic layer on at least one of their surfaces, prior to being supplied to the connecting station. The result is a 5-layered cross ply having the desired properties.

A favourable advanced development of the process according to the invention for the manufacture of a cross ply, wherein both the longitudinal plastic tapes and the transverse plastic tapes are coated in a single common coating station prior to being supplied to the connecting station, is set forth in claim 3. In this way, a 5-layered cross ply can be manufactured using a single coating station and the connecting station.

A cross ply having reinforced lateral edges, which at the same time are protected against splicing, can be obtained if the ends of the transverse plastic tapes, which protrude laterally beyond the longitudinal plastic tapes, are folded over and the folded ends of the transverse plastic tapes are connected with themselves or with the longitudinal plastic tapes, preferably by hot-air welding or extrusion welding.

The cross ply obtained by the process according to the invention can preferably be treated further by imprinting the outer surface of the cross ply or by shaping the cross ply into a tube, optionally with subsequent cutting and bag-bottom formation.

In order to achieve the above-indicated object, the invention also provides a device for the manufacture of a cross ply of plastic tapes, such as defined in claim 7.

The device according to the invention is characterized by high efficiency, low space requirement, low requirement for operating staff, low maintenance requirement and the smallest possible environmental impact.

Advantageously, the pressing means comprise a pair of press rolls, wherein preferably at least one of the press rolls is cooled.

In a preferred embodiment, the plastic-melt die is designed as a slot die.

Suitably, the means of transport for the transverse web pieces comprise a conveyor belt, preferably a vacuum conveyor belt. Therewith, high transport speeds are achievable, with the transverse web pieces, at the same time, being kept on the belt in a defined position.

For the purpose of an integrated progression of the production steps to be carried out by the device, the cutting means can be combined with transfer means, for example reciprocating suction bars, in order to transfer transverse web pieces, which have been cut, directly to the transport means. By this measure, the device's space requirement is further reduced.

Clean cuts in the transverse web are guaranteed if the cutting means are designed as a movable knife or as a hot wire.

Furthermore, the device according to the invention for the manufacture of a cross ply of plastic tapes can be equipped with one or several coating stations for coating the transverse plastic tapes and/or the longitudinal plastic tapes with a synthetic layer on at least one of their surfaces before they are supplied to the connecting station. Thereby, the properties of the manufactured cross ply are widely variable. Likewise, the transverse web can be produced in a production process and, synchronously therewith, the (coated or uncoated) longitudinal plastic tapes can be supplied to the connecting station so that a highly integrated device is created. Preferably, the coating station for transverse plastic tapes and/or the coating station for longitudinal plastic tapes comprise at least one die for the discharge of plastic melt as well as pressing and cooling means arranged downstream, preferably a pair of press and cooling rolls.

A particularly preferred embodiment of the device according to the invention for the manufacture of a cross ply of plastic tapes, which embodiment provides the highest possible throughput while offering consistently good quality, comprises a plastic-tape coating station for manufacturing a plastic web by coating a plurality of plastic tapes supplied in parallel to each other with a plastic melt, as well as downstream thereof, a separating means for the longitudinal separation of the plastic web into a transverse web and a longitudinal web, wherein deflection means are provided for supplying the transverse web to the cutting means and the longitudinal web can be supplied to the connecting station. By means of this embodiment, 5-layered cross plies are producible, with only one coating station and one connecting station being required.

In order to achieve the above-indicated object, the invention provides a cross ply of plastic tapes, such as defined in claims 17 and 18.

The cross ply according to the invention can have a 4-layered or a 5-layered design. It receives its biaxial mechanical strength from the layers of transverse plastic tapes and longitudinal plastic tapes arranged at an angle relative to each other, which advantageously are uniaxially stretched in order to increase the strength. The two layers of transverse plastic tapes and longitudinal plastic tapes are interconnected by the inner synthetic layer, whereby the inner synthetic layer itself is not exposed to any substantial mechanical stress but primarily serves to prevent splicing of the layers of transverse plastic tapes and longitudinal plastic tapes. On the one hand, the one or two outer synthetic layers serve for the protection of the layers of transverse plastic tapes and longitudinal plastic tapes arranged underneath, whereas, on the other hand, they also serve for imparting desired properties such as, e.g., slip resistance, resistance to ultraviolet light, impermeability to air or dust, good printability etc. to the cross ply. Transverse plastic tapes and longitudinal plastic tapes may be made from different materials and/or specifications. By perforation, air-permeable cross plies can also be produced.

The essential advantages of the cross ply according to the invention consist in its very high mechanical strength, based on the weight per unit area, the extensive variability of its properties, its universal applicability, its high resistance against a displacement of individual plastic tapes as well as its excellent further processability in subsequent processes, e.g., in the manufacture of bags, etc.

In a preferred embodiment of the cross ply, which provides great advantages in terms of the producibility of the cross ply, the layer of transverse plastic tapes consists of individual transverse web pieces successively arranged edge to edge and consisting of plastic tapes interconnected by the outer synthetic layer.

In an advanced development of the cross ply, edges of the transverse plastic tapes, which protrude laterally beyond the longitudinal plastic tapes, are folded over and connected with themselves or with the longitudinal plastic tapes so that an effective edge reinforcement is achieved.

Preferably, the synthetic material for the plastic tapes and for the individual synthetic layers is selected from polypropylene (PP), polyethylene (PE), in particular HDPE, LDPE or LLDPE, or mixtures thereof. In order to achieve desirable properties such as resistance to ultraviolet light, slip resistance, good weldability, antistatic properties, additives such as colour batch, calcium carbonate, filling materials, UV protectants etc. can be added to the synthetic material. In order to achieve a high-strength cross ply, the substrate material for the plastic tapes should be selected from film tapes, preferably mono- or coextruded film tapes, monoextruded tapes, monofilaments such as monofilaments from PET or PA as well as multifilament yarns. Preferably, the tapes are subjected to a stretching process. The outer lamination of the cross ply and the central synthetic connecting layer may have different thicknesses and compositions (e.g. a central layer having a high homopolymer content, an outer layer having a high copolymer content, for improving the weldability etc.). By using mechanical methods (e.g. needle felting), it is furthermore possible to adjust a defined permeability to gas and liquids, respectively, of the cross ply.

The invention is now illustrated in further detail by way of non-limiting exemplary embodiments, with reference to the drawings.

In the drawings,

FIG. 1 and FIG. 2 show schematically in perspective view and in side view, respectively, a first embodiment of a device according to the invention and of the process for the manufacture of a cross ply of plastic tapes, proceeding thereupon;

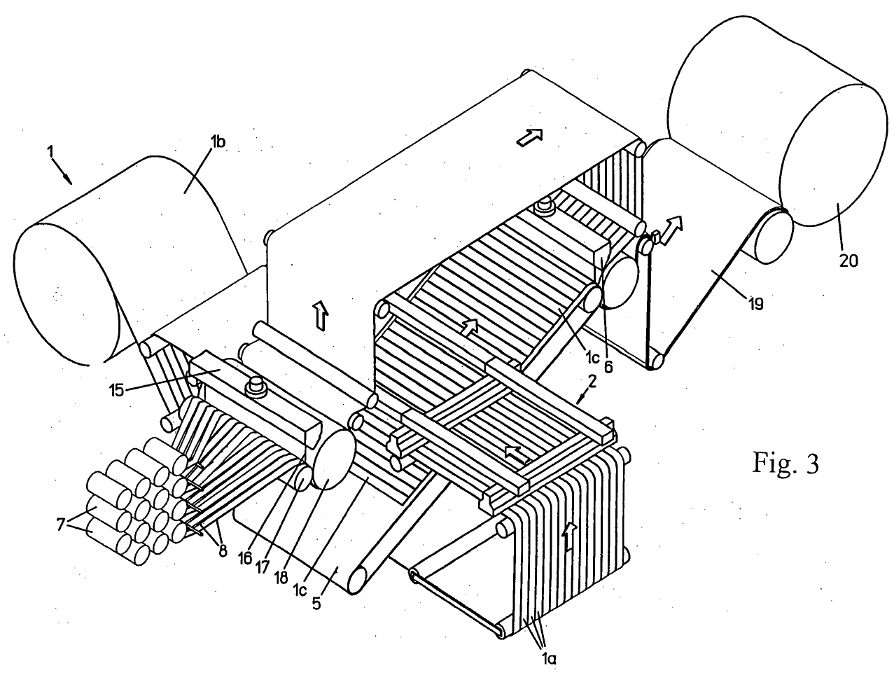

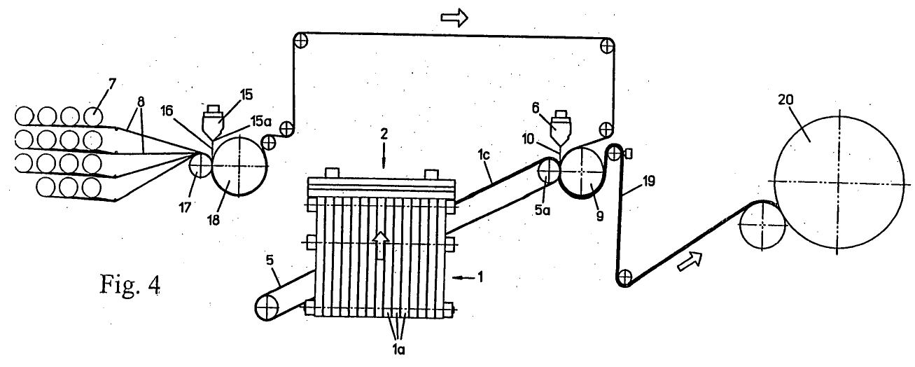

FIG. 3 and FIG. 4 show schematically in perspective view and in side view, respectively, a second embodiment of a device according to the invention for the manufacture of a cross ply of plastic tapes;

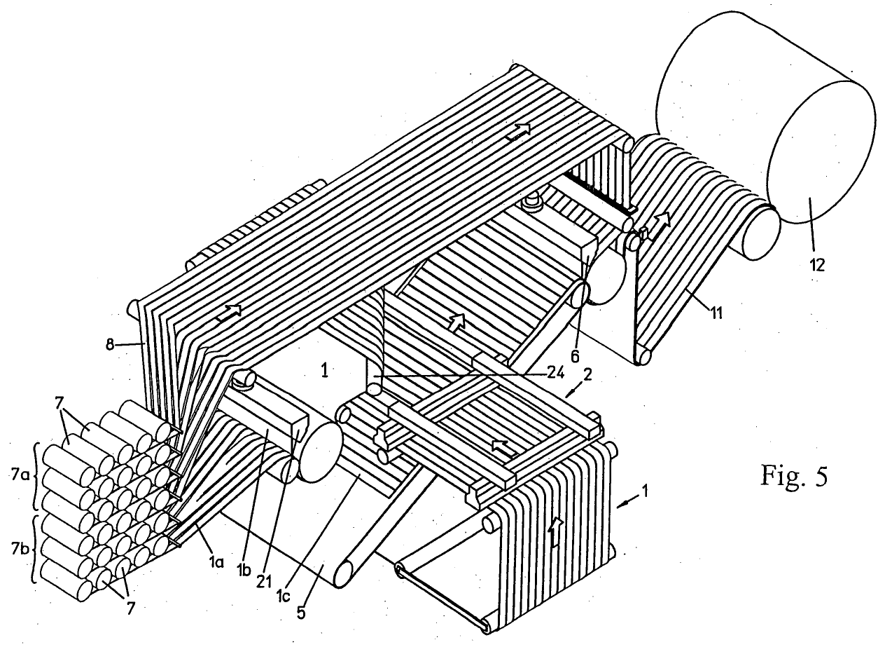

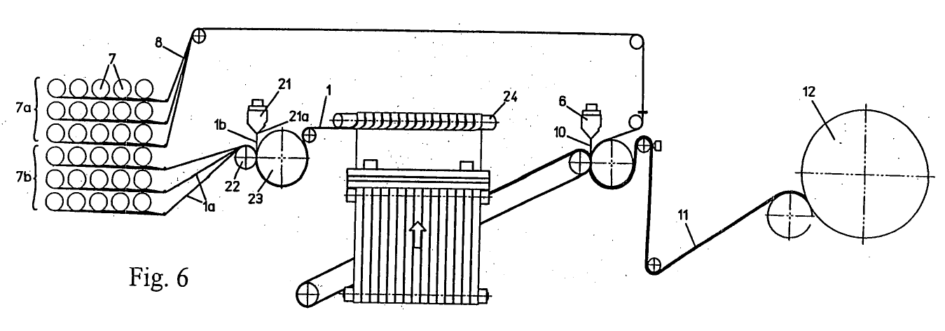

FIG. 5, FIG. 6 and FIG. 7 show schematically in perspective view and in side view, respectively, a third embodiment of a device according to the invention for the manufacture of a cross ply of plastic tapes, with FIG. 7 showing a detail of said embodiment in perspective view;

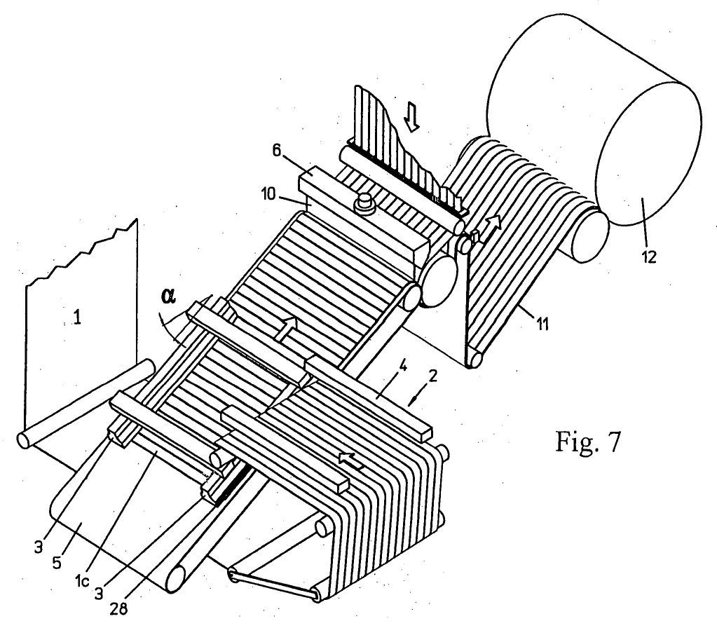

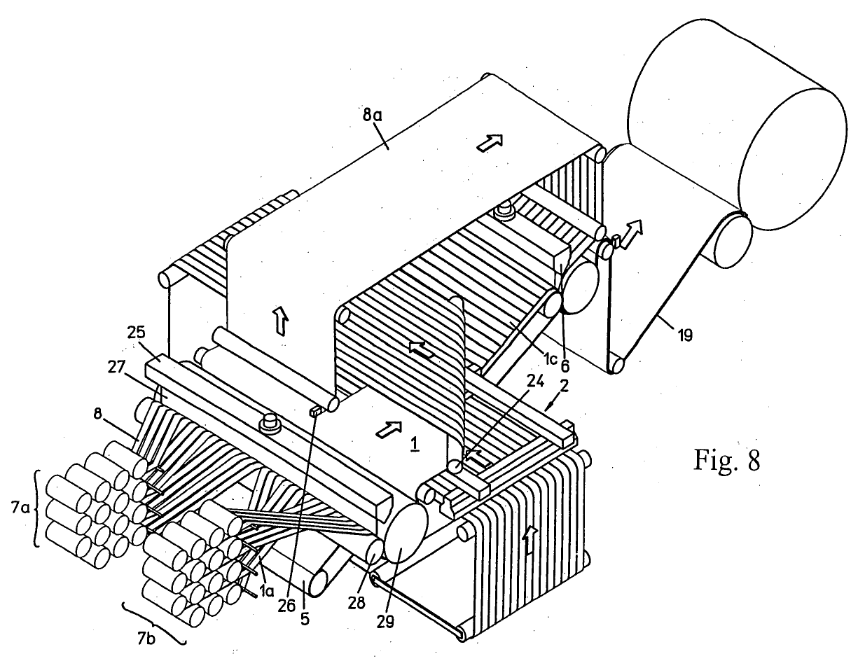

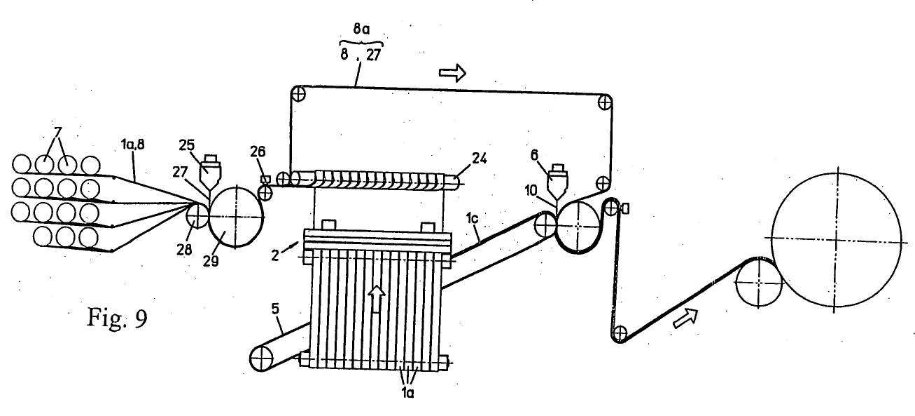

FIG. 8, FIG. 9 and FIG. 10 show schematically in perspective view and in side view, respectively, a fourth embodiment of a device according to the invention for the manufacture of a cross ply of plastic tapes, with FIG. 10 showing a detail of said embodiment in perspective view;

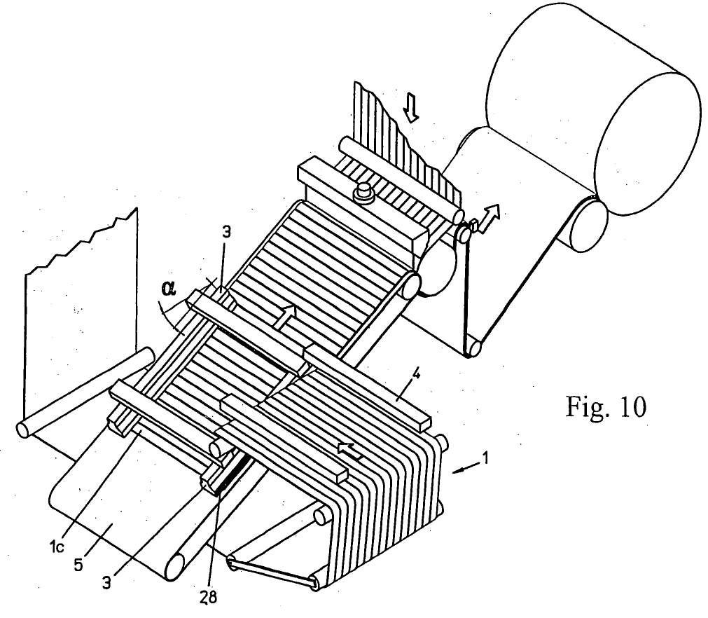

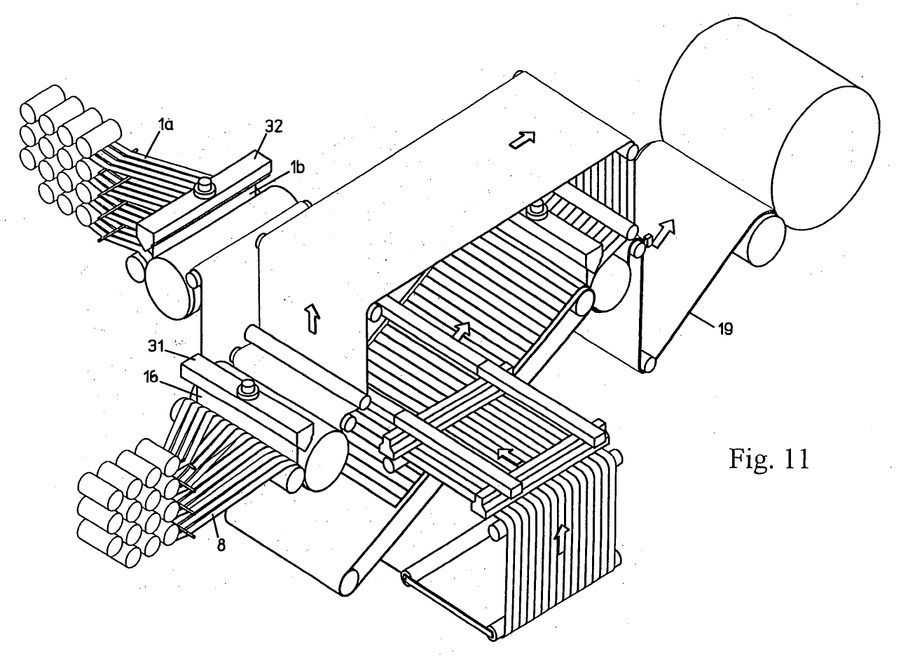

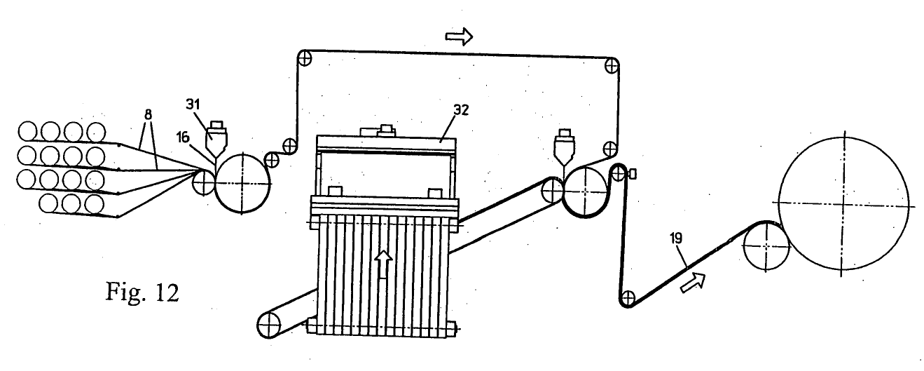

FIG. 11 and FIG. 12 show schematically in perspective view and in side view, respectively, a fifth embodiment of a device according to the invention for the manufacture of a cross ply of plastic tapes,

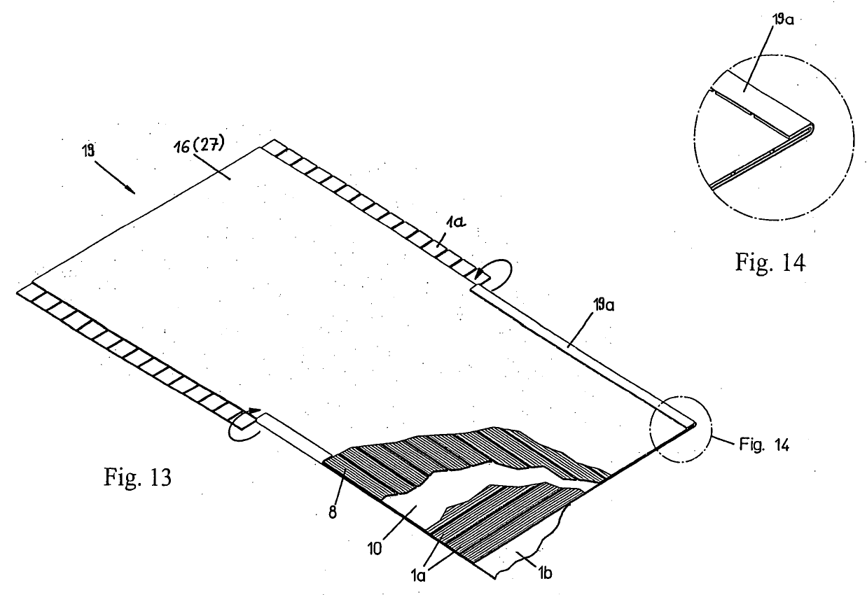

FIG. 13 shows in perspective view a 5-layered cross ply of plastic tapes, manufactured in a device according to the second, fourth or fifth embodiment;

FIG. 14 shows in perspective view a detail of the cross ply of FIG. 13;

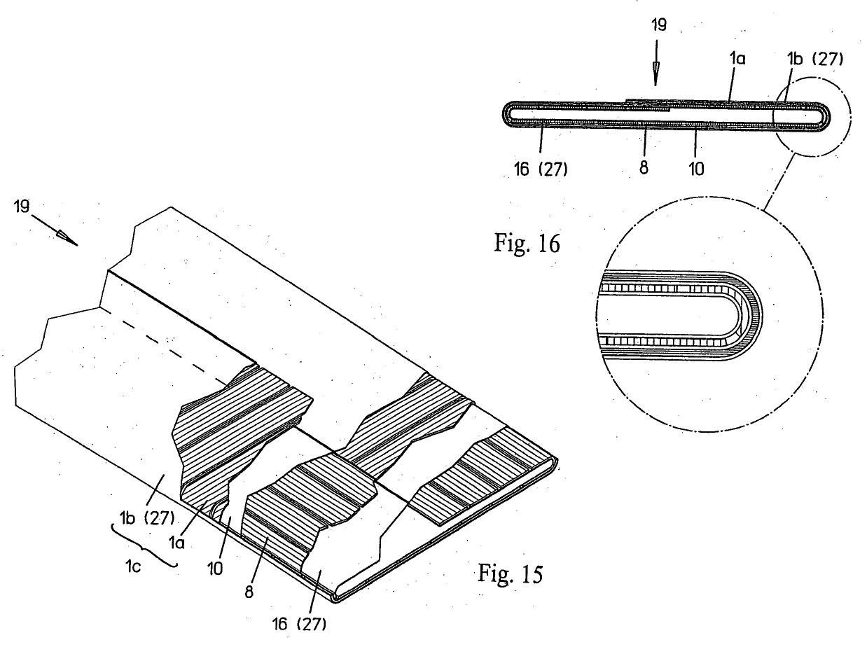

FIG. 15 shows in perspective view a 5-layered cross ply of plastic tapes, manufactured in a device according to the second, fourth or fifth embodiment;

FIG. 16 shows in cross-section and as an enlarged detail the cross ply of FIG. 15 shaped into a tube;

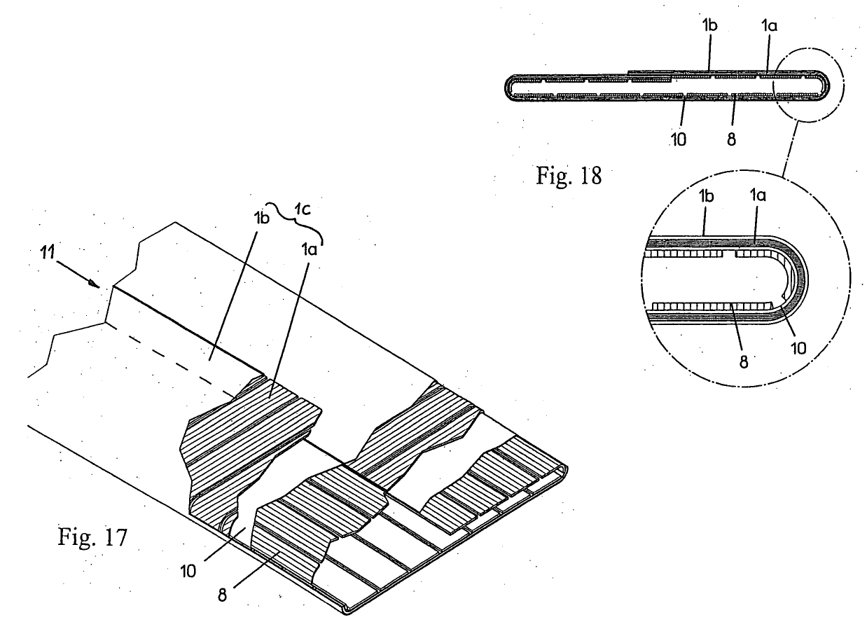

FIG. 17 shows in perspective view a 4-layered cross ply of plastic tapes, manufactured in a device according to the first or third embodiment; and

FIG. 18 shows in cross-section and as an enlarged detail the cross ply of FIG. 17 shaped into a tube.

In FIGS. 1 and 2, a first embodiment of a device according to the invention and of the process for the manufacture of a cross ply of plastic tapes, proceeding thereupon, is illustrated schematically in perspective view and in side view, respectively.

In a bearing (not illustrated), a transverse web 1 wound into a bale is provided. Said transverse web 1 consists of a plurality of transverse plastic tapes 1a arranged in parallel, which each are connected via a synthetic layer 1b with adjacent transverse plastic tapes 1a. Preferably, the transverse plastic tapes are uniaxially stretched plastic tapes from polypropylene (PP) or polyethylene (PE), in particular HDPE, LDPE or LLDPE, or mixtures thereof. The synthetic layer 1b, preferably a polyolefine layer, must only exhibit such strength that the transverse plastic tapes 1a are prevented from being offset, being separated or splicing during processing. However, the synthetic layer 1b is not required to bear loads. Via various deflection rollers 14a, 14b, 14c, 14d, the transverse web 1 is guided to an integrated cutting and transfer station 2 comprising two suction bars 3 arranged transversely to the feed direction (arrow A), which suction bars can be reciprocated by means of a slide 4, as well as cutting means (not illustrated), which may comprise a hot wire or a stationary or movable knife. The slide 4 draws the transverse web 1 adherent to the suction bars 3 across means of transport in the form of a conveyor belt 5, which preferably is designed as a vacuum conveyor belt. As soon as the transverse web is located above the conveyor belt 5 in the predetermined position, a transverse web piece 1c of a defined length is cut off and transferred to the conveyor belt 5. Alternatively, the transverse web piece 1c can also already be cut off before the slide 4 moves across the conveyor belt 5 so that the slide will transport only the transverse web piece.

The conveyor belt 5 moves continuously in the direction of arrow B, and the cycle for supplying the transverse web pieces 1c to the conveyor belt 5 is adjusted such that the transverse web pieces will end up lying edge to edge on the conveyor belt in a successive relation, with the longitudinal axes of the transverse plastic tapes extending at right angles relative to the conveying direction of the conveyor belt 5. The successively arranged transverse web pieces 1c are supplied to a connecting station 6 and are drawn into the connecting station 6 in such a way that the longitudinal axes of the transverse plastic tapes will lie transversely to the drawing-in direction.

It must be pointed out that the illustrated embodiments of the cutting, transfer and transport means are exemplary embodiments which currently are preferred. However, the scope of the invention is by no means limited to those examples but results exclusively from the attached patent claims.

Simultaneously with the procedure of supplying the transverse web, of cutting off transverse web pieces and of delivering them to the connecting station, from a plurality of bobbins 7, which are arranged in an unwinding creel (not illustrated), the respective plurality of, preferably uniaxially stretched, longitudinal plastic tapes 8 are unwound and, lying in parallel next to each other (either edge to edge or with a small distance between the tapes), they are supplied via various deflection rollers 13a, 13b, 13c to the connecting station 6 (see arrow C). The longitudinal plastic tapes are drawn in such that their longitudinal axes are positioned in the drawing-in direction.

The drawing-in of the transverse web pieces 1c and of the longitudinal plastic tapes 8 takes place between a pair of rolls, wherein one roll 5a belongs to the conveyor belt 5 and the other roll 9 is a cooled press roll. The connecting station 6 comprises a die 6a, preferably a slot die, from which a plastic melt layer 10 is introduced between the transverse web pieces 1c and the longitudinal plastic tapes 8 as they are drawn into the pair of rolls 5a, 9. By means of the cooled press roll 9, the plastic melt layer 10 is cooled and fixed. The plastic melt layer 10 connects the transverse web pieces 1c and the longitudinal plastic tapes 8 to form a cross ply 11, which exhibits a high biaxial strength due to the two layers of uniaxially stretched transverse plastic tapes and longitudinal plastic tapes, which are disposed relative to each other roughly at a right angle. The cross ply 11 thus produced consists of four layers, namely the synthetic layer 1b, the transverse plastic tapes 1a, the plastic melt layer 10 and the longitudinal plastic tapes 8, such as illustrated in FIG. 17. The cross ply 11 can subsequently be processed further, for example by folding over the longitudinal edges and hot-welding them in the folding and gluing station 30, by imprinting etc. Thereupon, the cross ply 11 is rolled up into a bale 12.

In the following, further exemplary embodiments are illustrated, wherein equal elements or elements with equal functions are provided in the drawings with the same reference numerals as in the first embodiment.

In FIGS. 3 and 4, a second embodiment of the device according to the invention and of the process for the manufacture of a cross ply of plastic tapes, proceeding thereupon, is illustrated schematically in perspective view and in side view, respectively.

As in the first embodiment, a transverse web 1 wound into a bale is provided, which was produced in a previous manufacturing process. Said transverse web 1 consists of a plurality of transverse plastic tapes 1a arranged in parallel, which each are connected via a synthetic layer 1b with adjacent transverse plastic tapes 1a. Via various deflection rollers, the transverse web 1 is guided to the integrated cutting and transfer station 2, where it is drawn across the conveyor belt 5 and is cut into transverse web pieces 1c of equal, predefined lengths, which are transferred edge to edge to the continuously moving conveyor belt 5 in a successive relation, with the longitudinal axes of the transverse plastic tapes extending at right angles relative to the conveying direction of the conveyor belt 5. The successively arranged transverse web pieces 1c are conveyed to the connecting station 6 on the conveyor belt 5 and are drawn into the connecting station in such a way that the longitudinal axes of the transverse plastic tapes will lie transversely to the drawing-in direction.

Simultaneously with the procedure of supplying the transverse web, of cutting off transverse web pieces and of delivering them to the connecting station, uniaxially stretched longitudinal plastic tapes 8 are unwound from a plurality of bobbins 7 and, lying in parallel next to each other, they are supplied via various deflection rollers to the connecting station 6. The longitudinal plastic tapes are drawn in such that their longitudinal axes are positioned in the drawing-in direction. However, in contrast to the first embodiment, the longitudinal plastic tapes 8 are passed through a coating station 15 prior to being drawn into the connecting station 6, in which coating station they are coated with a synthetic layer 16 linking the individual tapes 8. The coating station 15 comprises at least one die 15a, preferably a slot die, from which the synthetic layer 16 is applied to the tapes 8 as a melt. Thereby, the tapes, with the synthetic layer already applied, pass through a pair of press rolls 17, 18, wherein at least one roll is cooled.

The further procedure of manufacturing the cross ply corresponds to that of the first embodiment, i.e., the transverse web pieces 1c and the longitudinal plastic tapes 8 are drawn with their coating 16 between the pair of rolls 5a, 9, whereby it must be considered that the synthetic layer 16 and the synthetic layer 1b are located on the outside, i.e., they lie against the roll surfaces, and thus do not contact the plastic melt layer 10, which is introduced from the connecting station 6 between the transverse web pieces 1c and the longitudinal plastic tapes 8. By means of the cooled press roll 9, the plastic melt layer 10 is cooled and fixed. The plastic melt layer 10 connects the transverse web pieces 1c and the longitudinal plastic tapes 8 to form a cross ply 19, which exhibits a high biaxial strength due to the two layers of uniaxially stretched transverse plastic tapes and longitudinal plastic tapes, which are disposed relative to each other roughly at a right angle. The cross ply 19 thus produced consists of five layers, namely the synthetic layer 1b, the transverse plastic tapes 1a, the plastic melt layer 10, the longitudinal plastic tapes 8 and the synthetic layer 16, such as illustrated in FIGS. 13-16. Subsequently, the cross ply 19 is rolled up into a bale 20.

In FIGS. 5, 6 and 7, a third embodiment of the device according to the invention for the manufacture of a cross ply of plastic tapes is illustrated, which is to be regarded as a variant of the first embodiment. This embodiment differs from the first two embodiments in that the transverse web is not provided in an already prefabricated state but is produced in-line during the manufacture of the cross ply. For this purpose, transverse plastic tapes 1a are unwound from a subgroup 7b of the bobbins 7 and are supplied in parallel arrangement to a coating station 21, where they are coated with a synthetic layer 1b from a die 21a. Subsequent to the coating process involving the synthetic layer 1b, the transverse tapes pass through a pair of press rolls 22, 23, wherein at least one roll is cooled, in order to fix the synthetic layer 1b. The transverse web 1 thus produced is deflected by 90° at a turning bar 24 and subsequently is supplied underneath the conveyor belt 5 to the cutting and transfer station 2, where it is cut into transverse web pieces 1c, which are transferred to the conveyor belt 5 and conveyed to the connecting station 6. In a manner known from the first embodiment, longitudinal tapes 8 are unwound from a subgroup 7a of the bobbins 7 and are guided to the connecting station 6, where, such as in the first embodiment, they are connected with the transverse web pieces 1c to form a 4-layered cross ply 11 (illustrated in FIG. 17) by introducing a plastic melt layer 10 therebetween, which cross ply is rolled up into a bale 12. In FIG. 7, a detail of the third embodiment covering the cutting and transfer station is illustrated in further detail in perspective view. Thereby, the suction bars 3 have been moved by the slide 4 into a position above the conveyor belt 5. By means of a knife 28 attached to the trailing edge of one of the suction bars 3, a transverse web piece 1c has been cut from the transverse web 1, which piece is held by the suction bars 3. Thereupon, the portion of the slide 4 arranged above the conveyor belt is tilted downward by angle α in order to transfer the transverse web piece 1c to the conveyor belt 5 in this way.

In FIGS. 8, 9 and 10, a fourth embodiment of the device according to the invention for the manufacture of a cross ply of plastic tapes is illustrated. Thereby, longitudinal plastic tapes 8 are drawn from a first subgroup 7a of bobbins 7 and, synchronously therewith, transverse plastic tapes 1a are drawn from a second subgroup 7b of bobbins 7. The longitudinal plastic tapes 8 and the transverse plastic tapes 1a are supplied together in parallel orientation to a coating station 25, where (also together) they are coated with a synthetic layer 27. Subsequently, the tapes are drawn with their coating through a pair of press rolls 28, 29, wherein at least one roll is cooled. Afterwards, the web thus produced gets to a stationary knife 26, where it is divided longitudinally into two partial webs, namely into a longitudinal web 8a, consisting of the longitudinal plastic tapes 8 and the coating 27 (which is functionally equal to the synthetic layer 16 of the second embodiment), and a transverse web 1, consisting of the transverse plastic tapes 1a and the coating 27 (which is functionally equal to the synthetic layer 1b of the first to third embodiments). The further processing is performed as in the second embodiment, i.e., on the one hand, the coated longitudinal web 8a is supplied to the coating station 6, and, on the other hand, the transverse web 1 is turned at the turning bar 24 and is conveyed underneath the conveyor belt 5 to the cutting and transfer station 2, where it is cut into transverse web pieces 1c, which are transferred to the conveyor belt 5 and are conveyed one after another to the coating station 6. In the coating station 6, the longitudinal plastic tapes 8 and the transverse web pieces 1c are connected to form a 5-layered cross ply 19 by introducing a plastic melt layer 10 therebetween, which cross ply is illustrated in detail in FIGS. 13-16. In FIG. 10, a detail of the fourth embodiment covering the cutting and transfer station is illustrated in further detail in perspective view. Thereby, the suction bars 3 have been moved by the slide 4 into a position above the conveyor belt 5. By means of a knife 28 attached to the trailing edge of one of the suction bars 3, a transverse web piece 1c has been cut from the transverse web 1, which piece is held by the suction bars 3. Thereupon, the portion of the silde arranged above the conveyor belt is tilted downward by angle α in order to transfer the transverse web piece 1c to the conveyor belt 5 in this way.

In FIGS. 11 and 12, a fifth embodiment of the device according to the invention for the manufacture of a cross ply of plastic tapes is illustrated. This embodiment differs from the previous embodiments in that, in each case, a separate coating station is provided for coating the longitudinal tapes 8 as well as for coating the transverse tapes 1a, namely coating station 31 for applying a synthetic layer 16 to the longitudinal tapes 8, and coating station 32 for applying a synthetic layer 1b to the transverse tapes 1a. The further manufacturing process for the cross ply proceeds as described above by way of the second embodiment, which is why it is sufficient to refer to this specification. By means of this device, a 5-layered cross ply 19 is produced, such as illustrated in FIGS. 13-16.

In FIG. 13, the cross ply 19 produced by the second, fourth or fifth embodiment of the device according to the invention is illustrated in perspective view. It comprises five layers, namely an outer synthetic layer formed from the synthetic layer 1b of the transverse web pieces 1c, a layer of transverse plastic tapes 1a of the transverse web pieces 1c, an inner synthetic layer formed from the plastic melt layer 10 introduced in the connecting station, a layer of longitudinal plastic tapes 8, and a synthetic layer 16 or 27, respectively, with which the longitudinal plastic tapes 8 have been coated. The longitudinal plastic tapes 8 extend in the longitudinal direction of the cross ply 19; the transverse plastic tapes 1a extend transversely thereto, i.e. at right angles. The inner synthetic layer 10 connects the transverse plastic tapes 1a and the longitudinal plastic tapes 8, without itself having to display any load bearing strength. The cross ply's load bearing strength is based almost exclusively on the strength of the stretched longitudinal and transverse plastic tapes, which impart the desired biaxial strength to the cross ply due to their rectangular arrangement. As a result of stretching, the plastic tapes exhibit oriented molecules, whereby the strength is increased many times over. The plastic melt layer 10 connecting the layers of tapes and the outer synthetic layer 1b exhibit unoriented molecular chains. The outer synthetic layer 1b serves for imparting certain desired properties, such as, e.g., resistance to ultraviolet light, slip resistance, good printability etc. to the cross ply.

Polyolefines such as polypropylene (PP), polyethylene (PE), in particular HDPE, LDPE or LLDPE, or mixtures thereof are suitable materials for the plastic tapes and for the individual synthetic layers. Additives such as colour batch, calcium carbonate, filling materials, UV protectants etc. can additionally be added. An example of the cross ply according to the invention includes highly stretched PP (homopolymer) comprising admixtures (additives), possibly with a blend component of LDPE, with a coating from a mixture of PP and LDPE (homo- or copolymers), possibly plus additives for increasing weldability or adherence and additives for dyeing or adjusting various properties (protection against ultraviolet light, antistatic properties, conductivity etc.).

Depending on the application, film tapes, monoextruded tapes, other monofilaments as well as multifilament yarns are possible substrate materials. Furthermore, the use of mono- or coextruded film tapes or monofilaments from PET or polyamide (for increasing the strength) is conceivable. Coextruded multilayer film tapes from polyolefines are feasible as well. The areal coverage of the tapes or mono/multifilaments in the cross ply can vary between approximately 100% and a net-like structure. Furthermore, it is possible to use different substrate materials (e.g.: thin polyolefine tapes for filling, with PET yarns therebetween for strength reasons) in one cross ply. The outer lamination of the cross ply and the central adhesive layer (synthetic connecting layer 10) may have different thicknesses and compositions (e.g. a central layer having a high homopolymer content, an outer layer having a high copolymer content, for improving the weldability etc.). On principle, all variants conform with the intended use. By using mechanical methods (e.g. needle felting), it is furthermore possible to adjust a defined permeability to gas and liquids, respectively. The further processing to tubes for bags is basically performed via tube-forming plants involving longitudinal and transverse gluing or welding.

The thicknesses of the individual material layers are selected depending on the intended use of the cross ply. The cross ply according to the invention is used, for example, in the production of bags, for canvas fabrics, “big bags”, geotextiles etc. The weight per unit area of the cross ply can range from about 70-80 g/m² for normal bags and canvases to a multiple of this value for container, technical and special applications. If desired, the cross ply can be perforated in order to achieve air permeability. It is not necessary either that the tapes of the respective layer lie edge to edge, but they can also be arranged spaced apart from each other.

FIG. 14 shows an enlarged edge portion of the cross ply 19 of FIG. 13. It can be seen that an edge of the transverse plastic tapes 1a, which protrudes laterally beyond the longitudinal plastic tapes 8, is folded over together with the synthetic layer 1b connecting said tapes and is connected with the synthetic layer 16 or 27, respectively. In this way, a reinforced edge 19a of the cross ply, which prevents splicing, is formed. Naturally, a reinforced edge can also be formed in case of 4-layered cross plies. In this case, the plastic tapes 1a would be connected with the longitudinal plastic tapes 8.

In FIG. 15, the 5-layered cross ply 19, produced by the second, fourth or fifth embodiment of the device according to the invention for the manufacture of a cross ply and shaped into a tube, is illustrated in perspective view. FIG. 16 shows the shaped tube in cross-section. The cross ply of FIGS. 15 and 16 comprises, as mentioned, five layers, namely an outer synthetic layer formed from the synthetic layer 1b of the transverse web 1, a layer of transverse plastic tapes 1a of the transverse web 1, an inner synthetic layer formed from the plastic melt layer 10 introduced in the connecting station, a layer of longitudinal plastic tapes 8, and a synthetic layer 16 or 27, respectively, with which the longitudinal plastic tapes 8 have been coated. The synthetic layer 16 or 27, respectively, forms an inner layer during the tube forming of the cross ply, which provides clear advantages, for example, in the production of bags, compared with a manufacturing process involving endless woven tubes, since it is not necessary to produce the inner layer later.

According to the invention, also several layers of transverse and longitudinal plastic tapes can be shaped into a cross ply in order to achieve an even higher load bearing strength. For example, two or more 4- and 5-layered cross plies could be interconnected by introducing a plastic melt layer between two cross plies at a time. In the first or third embodiment of the device according to the invention, a cross ply produced in a previous production step might possibly also be used as a transverse web.

In FIG. 17, the cross ply 11 produced by the first or third embodiment of the device according to the invention is illustrated in perspective view. It comprises four layers, namely an outer synthetic layer formed from the synthetic layer 1b of transverse web pieces 1c of the transverse web 1, a layer of transverse plastic tapes 1a of transverse web pieces 1c of the transverse web 1 (see FIGS. 1 and 3), an inner synthetic layer formed from the plastic melt layer 10 introduced in the connecting station, and a layer of longitudinal plastic tapes 8. The longitudinal plastic tapes 8 extend in the longitudinal direction of the cross ply 11; the transverse plastic tapes 1a extend transversely thereto, i.e. at right angles. The inner synthetic layer 10 connects the transverse plastic tapes 1a and the longitudinal plastic tapes 8, without itself having to display any load bearing strength. The cross ply's load bearing strength is based almost exclusively on the strength of the stretched longitudinal and transverse plastic tapes, which impart the desired biaxial strength to the cross ply due to their rectangular arrangement. As a result of stretching, the plastic tapes exhibit oriented molecules, whereby the strength is increased many times over. The plastic melt layer 10 connecting the layers of tapes and the outer synthetic layer 1b exhibit unoriented molecular chains. With regard to the materials and properties of the cross ply, the above-mentioned 5-layered embodiment is referred to, the specification of which also applies to the 4-layered embodiment.

1. A process for the manufacture of a cross ply of, preferably stretched, plastic tapes, characterized by:
a) providing a transverse web (1) comprising a plurality of transverse plastic tapes (1a) arranged in parallel, which each are connected via a synthetic layer (1b) with adjacent transverse plastic tapes (1a),
b) cutting transverse web pieces (1c) of equal lengths from the transverse web (1) and conveying the transverse web pieces (1c) to a connecting station (6) in a successive relation, where the transverse web pieces (1c) are drawn in such that the direction of the longitudinal axis of the transverse plastic tapes lies at an angle, preferably roughly at a right angle, relative to the drawing-in direction (arrow B),
c) providing a plurality of longitudinal plastic tapes (8), preferably in bobbins (7) on unwinding creels,
d) supplying the longitudinal plastic tapes (8) in parallel arrangement to the connecting station (6),
e) connecting the longitudinal tapes (8) with transverse web pieces (1c) in each case supplied at the connecting station (6) to form a cross ply (11, 19) by introducing a plastic melt layer (10) between the longitudinal plastic tapes (8) and the transverse web pieces (1c) as they are passed through the connecting station (6), and subsequent cooling of the plastic melt layer so that the direction of the longitudinal axis of the longitudinal plastic tapes (8) runs at an angle, preferably roughly at a right angle, relative to the direction of the longitudinal axis of the plastic tapes of the transverse web pieces (1c),
f) treating further and/or winding up the cross ply (11, 19) thus produced.

2. A process according to claim 1, characterized in that providing the transverse web comprises providing a plurality of transverse plastic tapes (1a), preferably in bobbins (7) on unwinding creels, supplying the transverse plastic tapes (1a) in parallel arrangement to a coating station (21, 32), and connecting respective adjacent transverse plastic tapes (1a) in the coating station (21, 32) by applying a synthetic layer (1b) to at least one surface of the transverse plastic tapes (1a).

3. A process according to claim 1, characterized in that the longitudinal plastic tapes (8) are coated in a coating station (15, 31) with a synthetic layer (16) on at least one of their surfaces, prior to being supplied to the connecting station (6).

4. A process according to claim 3, characterized in that providing the transverse web (1) and coating the longitudinal plastic tapes (8) comprises providing a plurality of plastic tapes (1a, 8), preferably in bobbins (7) on unwinding creels, supplying the plastic tapes (1a, 8) in parallel arrangement to a coating station (25), connecting the plastic tapes (1a, 8) in the coating station (25) to form a web by applying a synthetic layer (27) to at least one surface of the plastic tapes (1a, 8), dividing the web thus obtained longitudinally into a longitudinal web (8a), which is supplied to the connecting station (6), and a transverse web (1), which is turned by a predetermined angle, preferably a right angle, and is cut into transverse web pieces (1c) of equal lengths, with the transverse web pieces (1c) being conveyed to the connecting station (6) in a successive relation.

5. A process according claim 1, characterized in that the further treatment of the cross ply (11, 19) comprises folding over ends of the transverse plastic tapes (1a), which protrude laterally beyond the longitudinal plastic tapes, and connecting the folded ends of the transverse plastic tapes with themselves or with the longitudinal plastic tapes (8), preferably by hot-air welding or extrusion welding.

6. A process according to claim 1, characterized in that the further treatment of the cross ply (11, 19) comprises imprinting the outer surface of the cross ply or shaping the cross ply into a tube, optionally with subsequent cutting and bag-bottom formation.

7. A device for the manufacture of a cross ply of, preferably stretched, plastic tapes, characterized by:
a) cutting means (28) for cutting transverse web pieces (1c) from a transverse web (1) comprising a plurality of transverse plastic tapes (1a) arranged in parallel, which each are connected via a synthetic layer (1b) with adjacent transverse plastic tapes (1a),
b) transport means (5) for supplying the transverse web pieces (1c) one after another to a connecting station (6) in such a way that the direction of the longitudinal axis of the transverse plastic tapes will lie basically transversely to the transport direction (arrow B) of the transverse web pieces (1c),
c) the connecting station (6) for connecting the transverse web pieces (1c) with a plurality of longitudinal plastic tapes (8), with the connecting station (6) comprising at least one plastic melt die (6a) for introducing a plastic melt layer (10) between the longitudinal plastic tapes (8) and the transverse web pieces (1c) as they are passed through the connecting station (6), pressing means (5a, 9) for pressing the longitudinal plastic tapes (8) and the transverse web pieces (1c) with the intermediate plastic melt layer (10) against one another, and cooling means (9) for cooling and solidifying the plastic melt layer (10).

8. A device for the manufacture of a cross ply according to claim 7, characterized in that the pressing means comprise a pair of press rolls (5a, 9), wherein preferably at least one of the press rolls (9) is cooled.

9. A device for the manufacture of a cross ply according to claim 7, characterized in that the plastic-melt die (6a) is designed as a slot die.

10. A device for the manufacture of a cross ply according to claim 7, characterized in that the means of transport for the transverse web pieces (1c) comprise a conveyor belt (5), preferably a vacuum conveyor belt.

11. A device for the manufacture of a cross ply according to claim 7, characterized in that the cutting means (28) are integral with transfer means, for example reciprocating suction bars (3), in order to transfer transverse web pieces (1c), which have been cut, to the transport means (5).

12. A device for the manufacture of a cross ply according to claim 7, characterized in that the cutting means (28) are designed as a movable knife or as a hot wire.

13. A device for the manufacture of a cross ply according to claim 7, characterized in that, upstream of the cutting means (28), a coating station (21, 32) for transverse plastic tapes is arranged in order to coat a plurality of transverse plastic tapes (1a) supplied in parallel with a synthetic layer (1b) on at least one of their surfaces.

14. A device for the manufacture of a cross ply according to claim 7, characterized in that, upstream of the connecting station, a coating station (15, 31) for longitudinal plastic tapes is arranged in order to coat the plurality of longitudinal plastic tapes (8) supplied in parallel with a synthetic layer (16) on at least one of their surfaces.

15. A device for the manufacture of a cross ply according to claim 13, characterized in that the coating station (21, 32) for transverse plastic tapes and/or the coating station (15, 31) for longitudinal plastic tapes comprise at least one die (15a, 21a) for the discharge of plastic melt as well as pressing and cooling means arranged downstream, preferably a pair of press and cooling rolls (17, 18; 22, 23).

16. A device for the manufacture of a cross ply according to claim 7, characterized by a plastic-tape coating station (25) for manufacturing a plastic web by coating a plurality of plastic tapes (1a, 8) supplied in parallel to each other with a plastic melt (27), as well as downstream thereof, a separating means (26) for the longitudinal separation of the plastic web into a transverse web (1) and a longitudinal web (8a), wherein deflection means (24) are provided for supplying the transverse web (1) to the cutting and transfer means (2) and the longitudinal web (8a) can be supplied to the connecting station (6).

17. A cross ply (11) of plastic tapes, preferably polyolefine tapes, characterized by an assembly from:
an outer synthetic layer (1b),
a layer of transverse plastic tapes (1a), which preferably are stretched,
an inner synthetic layer (10),
and a layer of longitudinal plastic tapes (8), which preferably are stretched and arranged at an angle, preferably roughly at a right angle, relative to the transverse plastic tapes (1a), with the inner synthetic layer (10) connecting the layer of transverse plastic tapes (1a) with the layer of longitudinal plastic tapes (8).

18. A cross ply (19) of plastic tapes, preferably polyolefine tapes, characterized by an assembly from:
an outer synthetic layer (1b, 27),
a layer of transverse plastic tapes (1a), which preferably are stretched,
an inner synthetic layer (10),
a layer of longitudinal plastic tapes (8), which preferably are stretched and arranged at an angle, preferably roughly at a right angle, relative to the transverse plastic tapes (1a), with the inner synthetic layer (10) connecting the layer of transverse plastic tapes (1a) with the layer of longitudinal plastic tapes (8),
and a further outer synthetic layer (16, 27).

19. A cross ply according to claim 17, characterized in that the layer of transverse plastic tapes consists of individual transverse web pieces (1c) successively arranged edge to edge and consisting of plastic tapes (1a) interconnected by the outer synthetic layer (1b, 27).

20. A cross ply according to claim 17, characterized in that ends of the transverse plastic tapes (1a), which protrude laterally beyond the longitudinal plastic tapes (8), are folded over and connected with themselves or with the longitudinal plastic tapes (8).

21. A cross ply according to claim 17, characterized in that the synthetic material for the plastic tapes (1a, 8) and for the individual synthetic layers (1b, 10, 16, 27) is selected from polypropylene (PP), polyethylene (PE), in particular HDPE, LDPE or LLDPE, or mixtures thereof.

22. A cross ply according to claim 21, characterized in that additives such as colour batch, calcium carbonate, filling materials, UV protectants etc. are added to the synthetic material.

23. A cross ply according to claim 17, characterized in that the substrate material for the plastic tapes (1a, 8) is selected from film tapes, preferably mono- or coextruded film tapes, monoextruded tapes, monofilaments such as monofilaments from PET or polyamide (PA) as well as multifilament yarns.

24. (canceled)

25. A cross ply (11) of plastic tapes, preferably polyolefine tapes, characterized by an assembly from:
an outer synthetic layer (1b),
a layer of transverse plastic tapes (1a), which preferably are stretched,
an inner synthetic layer (10),
and a layer of longitudinal plastic tapes (8), which preferably are stretched and arranged at an angle, preferably roughly at a right angle, relative to the transverse plastic tapes (1a), with the inner synthetic layer (10) connecting the layer of transverse plastic tapes (1a) with the layer of longitudinal plastic tapes (8), prepared in accordance with a process according to claim 1.

26. A cross ply (19) of plastic tapes, preferably polyolefine tapes, characterized by an assembly from:
an outer synthetic layer (1b, 27),
a layer of transverse plastic tapes (1a), which preferably are stretched,
an inner synthetic layer (10),
a layer of longitudinal plastic tapes (8), which preferably are stretched and arranged at an angle, preferably roughly at a right angle, relative to the transverse plastic tapes (1a), with the inner synthetic layer (10) connecting the layer of transverse plastic tapes (1a) with the layer of longitudinal plastic tapes (8),
and a further outer synthetic layer (16, 27), prepared in accordance with a process according to claim 1.
